(19) United States
(12) Patent Application Publication
(10) Pub. No.: US 2009/0322053 A1
(43) Pub. Date: Dec. 31, 2009

(54) BICYCLE WITH REDUCED AIR RESISTANCE AND METHOD APPLIED THEREBY

(76) Inventor: Jochim AERTS, Tessenderlo (BE)

Correspondence Address: BACON & THOMAS, PLLC, 625 SLATERS LANE, FOURTH FLOOR, ALEXANDRIA, VA, 22314-1176, US

(21) Appl. No.: 12/492,450

(22) Filed: Jun. 26, 2009

(30) Foreign Application Priority Data
Jun. 27, 2008 (BE) 2008/0357

(51) Int. Cl. B62K 3/02; B05D 5/02

(52) U.S. Cl. 280/274; 427/256

(57) ABSTRACT

Bicycle with reduced air resistance, which bicycle is provided with a frame and a fork made of tubes which are provided with a smooth finishing layer, characterized in that the finishing layer is provided with a non-smooth structure for reducing the air resistance in select places.

The present invention concerns a bicycle with a reduced air resistance, in particular a competition bicycle with such a reduced air resistance.

Traditionally, the air resistance of a competition bicycle is reduced by applying a uniform, matt or shiny layer of varnish or paint on those constituent parts of the bicycle that are most exposed to the air flow to thus create a frictional resistance which is as small as possible between the components of the bicycle on the one hand, and the air flow flowing along the latter on the other hand.

Another traditional technique for lowering the air resistance of a competition bicycle consists in providing a special design to said constituent parts, in particular to the frame and the fork.

The design whereby the section of said parts has the profile of a water drop is already known in this context.

While riding, the air flow hereby first acts on the round part of the water drop profile and is subsequently actually split in two similar, mirror image-forming partial flows, each flowing over the side edges of the profile on their own side, to finally, after having left the narrower, conical end of said profile, flow together again.

A limitation hereby is that, as of a certain speed of the air flow, and depending on different factors, the partial flows flowing over the drop-shaped profile no longer stay close to the surface of the profile but come off the latter.

As a result, an underpressure is created near the conical part of the drop-shaped profile, which underpressure, depending on the place where and the intensity with which it occurs, will have an air resistance increasing effect rather than an air resistance reducing effect.

The present invention aims to remedy the above-mentioned and other disadvantages by providing a bicycle with reduced air resistance, which bicycle is provided with a frame and a fork made of tubes which are provided with a smooth finishing layer, and whereby the finishing layer is provided with a non-smooth structure in select places so as to reduce the air resistance.

An advantage thereof is that in a simple, but efficient manner, without any further transformations to the frame or the fork, or to other constituent parts of the bicycle, the air resistance can be actually reduced.

Another advantage is that the non-smooth finishing layer can be composed of simple and cheap components.

Yet another advantage is that the finishing layer with a non-smooth structure can be easily and quickly provided on already existing bicycles.

Yet another advantage is that the finishing layer can be provided in different ways in this case, i.e. in the shape of a lacquered strip, a print, an adhesive strip or the like.

Another advantage is that the non-smooth finishing layer can be provided in select places by means of an appropriate surface treatment of an underlying layer, for example by providing a profile or relief resulting from a chemical or mechanical finishing.

Another advantage is that the non-smooth finishing layer can be easily formed in select places by providing granular material with an appropriate composition on a wet hardening base.

According to a preferred characteristic of the invention, the non-smooth finishing layer in the shape of a lacquered strip is only provided right before those places where the laminar air current around the tubes of the frame or the fork comes off while riding.

These places are initially determined by means of wind tunnel tests whereby the air flow is visualized on the frame and the fork by means of oil paint containing talcum powder applied to the bicycle.

The non-smooth finishing layer which is provided thereby consists of a narrow strip of some 5 mm wide, which extends over practically the entire length of the tubes.

The finishing layer according to the invention thereby has a non-smooth structure in the shape of granules whose grain size is situated between 70 and 130.

These granules are suspended beforehand in the liquid lacquer, or they may be sprayed or powdered on it as separate in a second phase, whereby the lacquer rather serves as a binding agent or adhesive for the granules on a previously provided underlayer in that case.

In a further embodiment, the non-smooth finishing layer is formed of strips of an appropriate carrier, for example a plastic film or metal foil having the required surface structure and which are applied in the select places on the tubes, preferably by means of an adhesive.

In another preferred embodiment, the non-smooth strips are applied in the select places on the tubes by means of a transfer or printing process.

In yet another preferred embodiment, the lacquer is applied in said select places in the form of a gel or a paste by means of a structure or relief forming application method, for example by a profile roller, or by subsequently, before the lacquer has entirely dried, forming a required profile or relief into it.

In a further preferred embodiment, a non-smooth surface structure is formed on an existing underlayer by finishing it in a mechanical or chemical way or by means of light treatment.

The invention also concerns a method for reducing the air resistance of a bicycle, whereby a finishing layer with a non-smooth structure is provided in select places so as to reduce the air resistance.

The invention also concerns a method which consists in forming or providing a non-smooth finishing layer, for example with a grainy structure, in select places of a competition bicycle, for example in the shape of a lacquered layer and/or a print and/or an adhesive strip or the like, or by finishing an appropriate base layer in a chemical or mechanical manner or by means of light energy in a second step until the required, non-smooth surface structure is obtained.

In order to better explain the characteristics of the invention, the following preferred embodiment of a bicycle and a method according to the invention are described by way of example only without being limitative in any way, with reference to the accompanying drawings, in which:

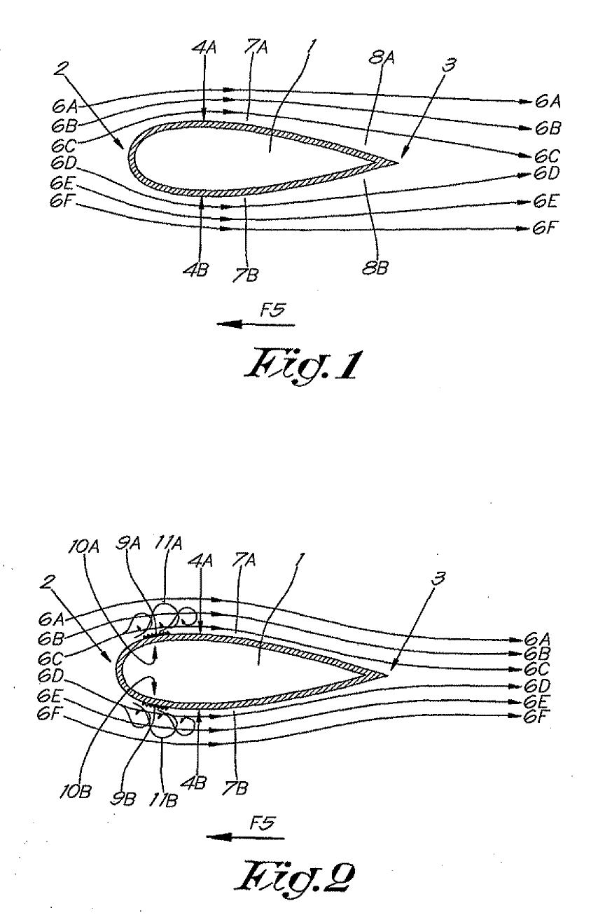

FIG. 1 schematically represents a cross section of the tube of a competition bicycle and an air flow flowing all around the latter according to the present state of the art;

FIG. 2 represents the same cross section of the tube represented in FIG. 1, but in the embodiment of the invention.

FIG. 1 schematically represents a cross section of a tube 1 which, according to the present state of the art, is made in the shape of a drop with a round tip 2 on the front side, i.e. seen in the direction of flow 6A-6F, and a pointed edge 3 on the opposite rear side, which are connected to one another via the sides 4A, 4B respectively, and whose surfaces continue in a fluent manner.

The surface of the tube 1 is hereby provided with a smooth finishing layer provided in an evenly manner, for example in the shape of a varnish layer or lacquered layer.

The air flow which is hereby created in the opposite sense as the tube 1 moves forward in the direction indicated by arrow F5 is schematically represented by the flow pattern and the arrows 6A-6F.

FIG. 2 schematically represents the same cross section as in FIG. 1, but this time with the non-smooth finishing layers 9A, 9B respectively provided on the tube 1 according to the invention.

The constituent parts and the air flow which is created in the opposite direction when riding in the direction indicated by arrow F5 are hereby schematically represented in a similar way as in FIG. 1 by the flow pattern and the arrows 6A-6F.

The influence on the air resistance of the applied non-smooth structure is as follows.

Starting from the condition as represented in FIG. 1, we see how the round tip 2 of the pipe 1 splits the air flow 6A-6F in two partial flows 6A-6C and 6D-6F respectively, which each flow over the sides 4A and 4B of the drop-shaped profile of the tube, each on their side, to subsequently, after having passed the more conical rear side 3, converge again so as to form the composed flow 6A-6F.

Since, depending on different factors, when a certain critical flow velocity is exceeded, the partial flows 6A-6C and 6D-6F no longer stay close to the surfaces 4A and 4B respectively of the drop-shaped profile of the tube 1, but partially come off the latter in the places 7A, 7B respectively, an underpressure will be created in the zones indicated by 8A, 83 respectively.

This underpressure exerts a force on the moving profile which is opposite to the direction of movement F5, so that, when riding, an air resistance increasing effect will be obtained rather than an air resistance reducing effect, depending on the place where and the intensity with which said underpressure occurs.

If, as indicated in FIG. 2, according to the invention, non-smooth finishing layers 9A and 9B are provided in select places 10A and 10B, a rather turbulent flow pattern will be created, as is schematically represented by 11A and 11B respectively.

This new flow pattern makes sure that the partial flows 6A-6C and 6D-6F respectively no longer come off the profile surface of the tube 1 in the vicinity of the places 7A and 7B, as represented in FIG. 1, but by contrast stay close to the latter, as represented in FIG. 2, this time without any counteracting local underpressure being created in the zones 8A and 8B.

This is advantageous in that the non-smooth finishing layers 9A and 9B according to the invention are provided in places where the partial flows 6A-6C and 6D-6F would normally no longer stay close to the profile surface of the tube 1, represented by the zones 7A and 7B.

Better still, these non-smooth finishing layers 9A and 9B are provided in a place right before said zones 7A and 7B, seen in the direction of the air flows 6A-6C and 6D-6F, namely in a place as indicated by 10A and 10B in FIG. 2.

As a result, the air resistance of a bicycle according to the invention is actually reduced in comparison with the condition representing the present state of the art and as discussed with reference to FIG. 1.

The most appropriate place for providing the non-smooth finishing layer according to the invention can be determined, for example, by means of wind tunnel tests whereby the air flow is visualized on the frame and the fork by means of oil paint containing talcum powder which is applied to the bicycle.

The present invention also concerns a method which makes it possible to provide the air resistance reducing, non-smooth finishing layers 9A,9B in a select manner on parts of a competition bicycle.

The present invention is by no means restricted to the embodiments and methods described by way of example and represented in the accompanying drawings; on the contrary, a bicycle with reduced air resistance according to the invention can be made in all sorts of shapes and dimensions and according to different methods while still remaining within the scope of the invention.

1-15. (canceled)

16. Bicycle with reduced air resistance, comprising a frame and a fork made of tubes which are provided with a smooth finishing layer, wherein the finishing layer includes a non-smooth structure in select places for reducing the air resistance of the frame and fork.

17. Bicycle according to claim 16, wherein the non-smooth structure is a grainy structure.

18. Bicycle according to claim 17, wherein the grainy structure is obtained by locally providing a lacquer on the frame and/or the fork in which granules have been mixed.

19. Bicycle according to claim 17, wherein the grainy structure is obtained by locally providing a print or an adhesive strip on the frame and/or the fork in which granules have been mixed or on which granules have been applied.

20. Bicycle according to claim 18, wherein the granules have a grain size between 70 and 130.

21. Bicycle according to claim 17, wherein the grainy structure is provided in those places where the air flow circulating over the tubes of the frame and/or of the fork separates from the tubes while riding, or, as seen in the direction of flow just upstream of the separation.

22. Bicycle according to claim 17, wherein the grainy structure is only provided in those places where air flow around the tubes of the frame and/or of the fork separates from the tubes while riding or, as seen in the direction of flow, just upstream of the separation.

23. Bicycle according to claim 17, wherein the grainy structure is provided in a narrow zone extending in the longitudinal direction of the tubes of the frame and/or of the fork.

24. Bicycle according to claim 23, wherein the narrow zone is located in the direction of the bicycle motion seen from the sides of the tubes.

25. Bicycle according to claim 23, wherein the narrow zone is located on the side of the tubes between a front round tip of a cross section and a place where the cross section is the widest.

26. Bicycle according to claim 23, wherein the width of the narrow zone is on the order of magnitude of a few millimeters.

27. Bicycle according to claim 23, wherein the narrow zone extends over the entire or almost the entire length of the tubes.

28. Bicycle according to claim 16, wherein the place where the air flow circulating over the tubes of the frame and/or of the fork separate is determined by applying the air flow visualization technique in a wind tunnel.

29. Method for reducing the air resistance of a bicycle, comprising applying a finishing layer with a non-smooth structure in select places so as to reduce the air resistance.

30. Method according to claim 29, including using as a finishing layer a lacquered layer and/or a print and/or an adhesive strip or the like having a grainy structure.
